(19) United States
(12) Patent Application Publication
(10) Pub. No.: US 2025/0325154 A1
(43) Pub. Date: Oct. 23, 2025

(54) UNIVERSAL BUBBLE FACIAL CLEANING INSTRUMENT WITH PURIFICATION APPARATUS

(71) Applicants: Shenzhen Tri-Core Technology Development Co., Ltd, Shenzhen (CN); Shenzhen Yihongyuan Technology Co., Ltd., Shenzhen (CN)

(72) Inventors: Deyu Chen, Beihai (CN); Peng Cheng, Jining (CN)

(21) Appl. No.: 18/651,592

(22) Filed: Apr. 30, 2024

(30) Foreign Application Priority Data
Apr. 23, 2024 (CN) 202420852349.7

(51) Int. Cl. A47K 7/04; B01D 29/15; B01D 39/18; B01D 39/20

(52) U.S. Cl. CPC A47K 7/04; B01D 29/15; B01D 39/18; B01D 39/2065; B01D 2201/0423; B01D 2201/34; B01D 2201/4015; B01D 2239/0618; B01D 2239/065

(57) ABSTRACT

A universal bubble facial cleaning instrument with a purification apparatus relates to the technical field of bubble facial cleaning instrument devices. A water purification mechanism is arranged in a middle outer member, one end of the water purification mechanism is connected with a bubble generator, a composite filter element is rotatably arranged in a filter element groove member, a front end of the filter element groove member is hermetically provided with a filter element bottom cover, an outlet section at a tail end of the filter element groove member is provided with a fixed edge with one side close to the composite filter element provided with a gap blocker, a tail end of the middle outer member is provided with a water outlet outer member clamped with the fixed edge, and a bubble outlet of the bubble generator is exposed from a bottom opening of the water outlet outer member.

### CROSS REFERENCE TO RELATED APPLICATIONS

This application claims foreign priority of Chinese Patent Application No. 202420852349. 7, filed on Apr. 23, 2024 in the China National Intellectual Property Administration, the disclosures of all of which are hereby incorporated by reference.

### TECHNICAL FIELD

The present application relates to a universal bubble facial cleaning instrument with a purification apparatus, and relates to the technical field of bubble facial cleaning instrument devices.

### BACKGROUND OF THE PRESENT INVENTION

Bubble facial cleaning instrument is a skin cleaning device commonly used in modern people's daily life, and mostly used by women, and the bubble facial cleaning instrument facilitates the daily cleaning of users due to a compact and easy-to-use structure.

The bubble facial cleaning instrument needs to be connected with water in use, the water or a mixed liquid is converted into micro bubbles by a microbubble generator to act on skin, so as to achieve the purpose of cleaning. The device needs to be cleaned after use to prevent dirt from depositing in the device to adversely affect subsequent use. Existing bubble facial cleaning instruments are usually used directly after the water enters through a water inlet end, but not all of the instruments are used with pure water, and ordinary tap water inevitably contains some impurities, which will affect the use effect. Moreover, because most of the devices are of a fixed integrated structure, if an angle of use is changed in use, an angle of the water inlet end will also change, which often leads to collision with a water inlet device, and the same problem will be encountered during cleaning. Therefore, a universal bubble facial cleaning instrument with a purification apparatus is provided to solve the problems in the prior art.

### SUMMARY OF THE PRESENT INVENTION

The present application is intended to provide a universal bubble facial cleaning instrument with a purification apparatus aiming at the defects or deficiencies in the prior art, wherein a water purification mechanism is arranged in the facial cleaning instrument to be connected with a microbubble generator, so that water to be used is purified before use to obtain a better cleaning effect, and the water purification mechanism can rotate by 360 degrees, so that it is convenient to change a cleaning position by multi-angle rotation when a water inlet direction is fixed, and it is also convenient to clean the bubble generator by any rotation angle after use.

In order to achieve the above object, the present application adopts the following technical solution: a universal bubble facial cleaning instrument with a purification apparatus comprises a middle outer member 1, wherein a water purification mechanism 4 is arranged in the middle outer member 1, one end of the water purification mechanism 4 is connected with a bubble generator 5, the water purification mechanism 4 comprises a composite filter element 4-2 and a filter element groove member 4-3, the composite filter element 4-2 is rotatably arranged in the filter element groove member 4-3, a front end of the filter element groove member 4-3 is hermetically provided with a filter element bottom cover 4-1, an outlet section at a tail end of the filter element groove member 4-3 is provided with a fixed edge 4-3-1, one side of the fixed edge 4-3-1 close to the composite filter element 4-2 is provided with a gap blocker 4-7, a shape of an outer edge of the gap blocker 4-7 is matched with an internal shape of a tail end of the middle outer member 1, the tail end of the middle outer member 1 is provided with a water outlet outer member 3, the water outlet outer member 3 is clamped with the fixed edge 4-3-1, and a bubble outlet of the bubble generator 5 is exposed from a bottom opening of the water outlet outer member 3.

Further, the outlet section at the tail end of the filter element groove member 4-3 is also provided with a clamping pin 4-8, and the clamping pin 4-8 is two symmetrical semi-annular clamping sheets and clamped at a bayonet arranged on the outlet section at the tail end of the filter element groove member 4-3.

Further, an outlet water flow channel member 4-4 is arranged in the outlet section at the tail end of the filter element groove member 4-3, the outlet water flow channel member 4-4 is hermetically connected with the filter element groove member 4-3 through a sealing ring, and a bottom portion of the outlet water flow channel member 4-4 is provided with a water outlet to be hermetically connected with the bubble generator 5.

Further, a top portion of the filter element groove member 4-3 is provided with a water inlet, the water inlet is hermetically provided with a copper insert 4-6, the copper insert 4-6 is hermetically provided with a quick inserting plug 4-5, and the quick inserting plug 4-5 penetrates through the middle outer member 1.

Further, a front end of an inner wall of the water outlet outer member 3 is provided with a first buckle 3-1 and a second buckle 3-2, the first buckle 3-1 is clamped with one side of the fixed edge 4-3-1 close to the gap blocker 4-7, and the second buckle 3-2 abuts against an outer ring of the clamping pin 4-8.

Further, a front end of the filter element bottom cover 4-1 is provided with a clamping plate, and the clamping plate is provided with a fixing buckle 4-9.

Further, one side of the middle outer member 1 is provided with a filter element outer bottom cover 2, an inner wall of the filter element outer bottom cover 2 is provided with a third buckle 2-1, and the third buckle 2-1 is clamped with the fixing buckle 4-9.

Further, the composite filter element 4-2 is composed of a multilayer non-woven fabric layer 4-2-2, a PP cotton layer 4-2-3 and a carbon fiber layer 4-2-4 from the outside to the inside, and two ends of the composite filter element 4-2 are silica gel gaskets 4-2-1.

After adopting the above technical solution, the present application has the beneficial effects that: the water purification mechanism is arranged in the facial cleaning instrument to be connected with the microbubble generator, so that water to be used is purified before use to obtain a better cleaning effect, and the water purification mechanism can rotate by 360 degrees, so that it is convenient to change a cleaning position by multi-angle rotation when a water inlet direction is fixed, and it is also convenient to clean the bubble generator by any rotation angle after use.

### DESCRIPTION OF THE DRAWINGS

In order to illustrate technical solutions in embodiments of the present application or in the prior art more clearly, the drawings to be used in the descriptions of the embodiments or the prior art will be briefly described hereinafter. Obviously, the drawings in the following descriptions are merely some embodiments of the present application, and for those of ordinary skills in the art, other drawings may also be obtained based on these drawings without going through any creative work.

FIG. 1 is a schematic structural diagram of the present application;

FIG. 2 is a second perspective view of FIG. 1;

FIG. 3 is a schematic structural diagram of a water purification mechanism 4 in the present application;

FIG. 4 is a schematic diagram of an exploded structure of the present application;

FIG. 5 is a schematic structural diagram of a filter element outer bottom cover 2 in the present application;

FIG. 6 is a schematic structural diagram of a water outlet outer member 3 in the present application;

FIG. 7 is a schematic structural diagram of a composite filter element 4-2 in the present application;

FIG. 8 is a schematic diagram of a rotating use state of the present application;

FIG. 9 is a schematic diagram of a disassembled state of the water purification mechanism 4 in the present application; and

FIG. 10 is a schematic diagram of an internal structure of the present application.

Description of reference numerals: 1 refers to middle outer member, 2 refers to filter element outer bottom cover, 3 refers to water outlet outer member, 4 refers to water purification mechanism, 5 refers to bubble generator, 2-1 refers to third buckle, 3-1 refers to first buckle, 3-2 refers to second buckle, 4-1 refers to filter element bottom cover, 4-2 refers to composite filter element, 4-3 refers to filter element groove member, 4-4 refers to outlet water flow channel member, 4-5 refers to quick inserting plug, quick plug connector, 4-6 refers to copper insert, 4-7 refers to gap blocker, 4-8 refers to clamping pin, 4-9 refers to fixing buckle, and 4-3-1 refers to fixed edge.

### DETAILED DESCRIPTION OF PREFERRED EMBODIMENTS

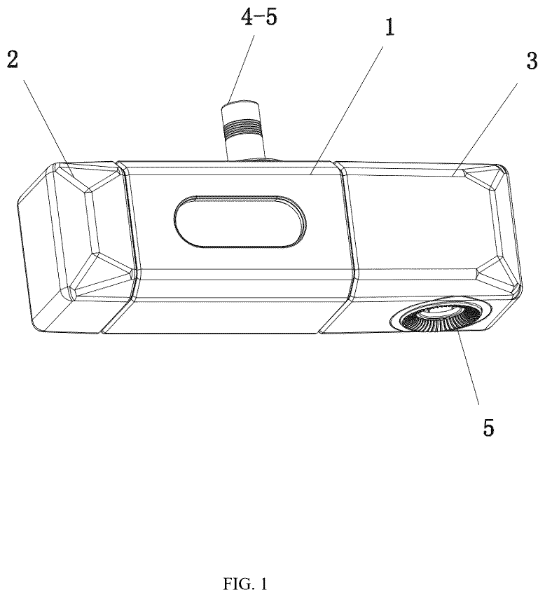

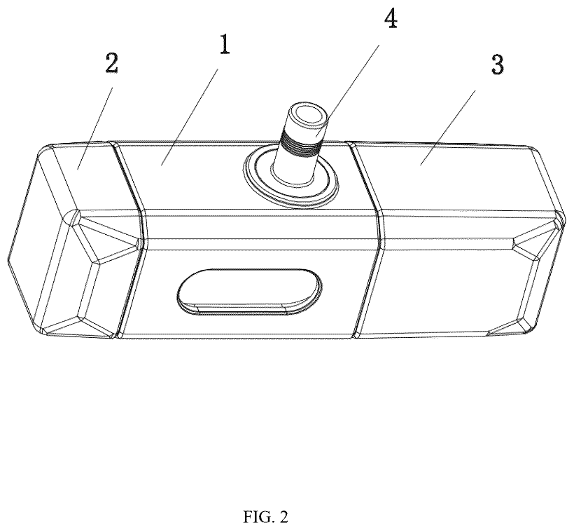

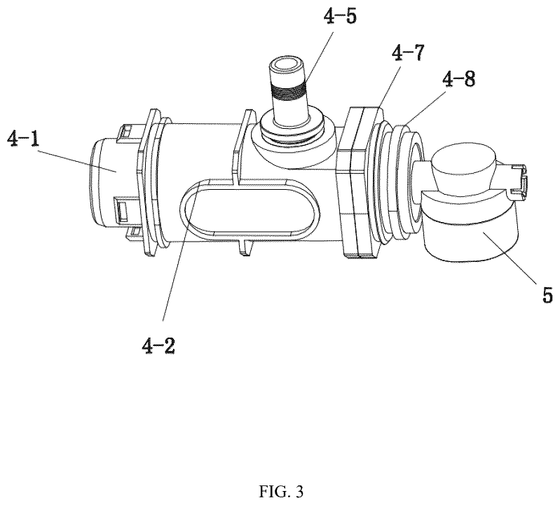

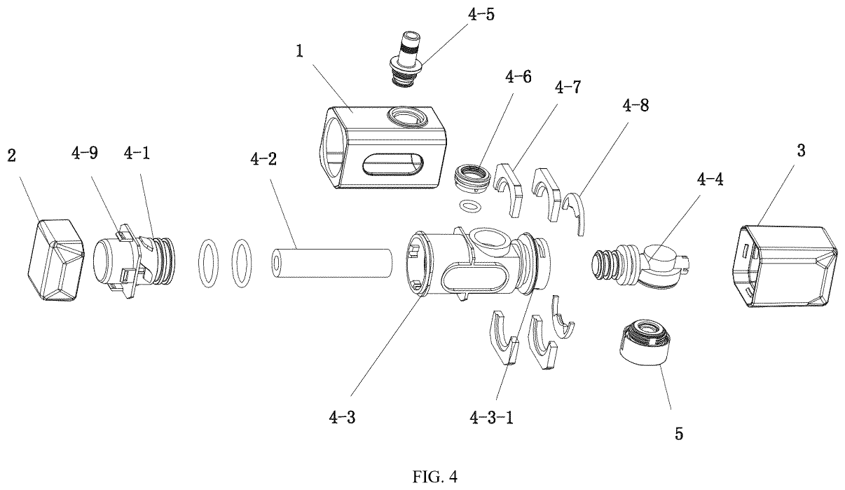

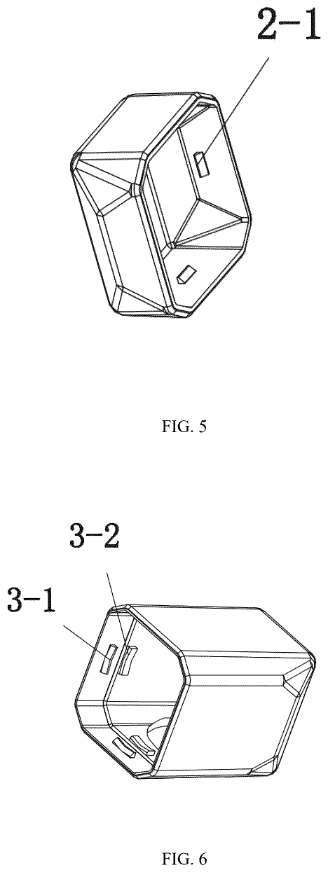

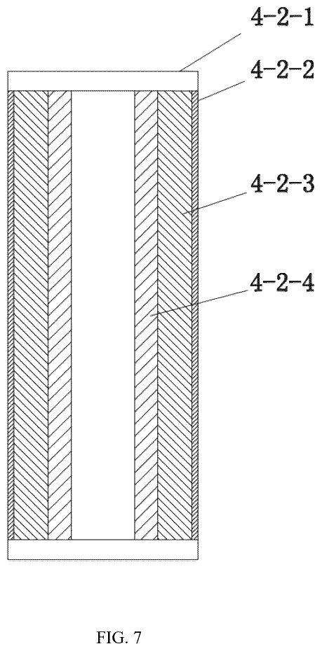

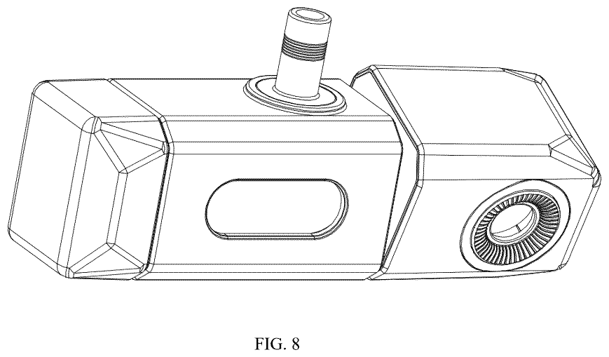

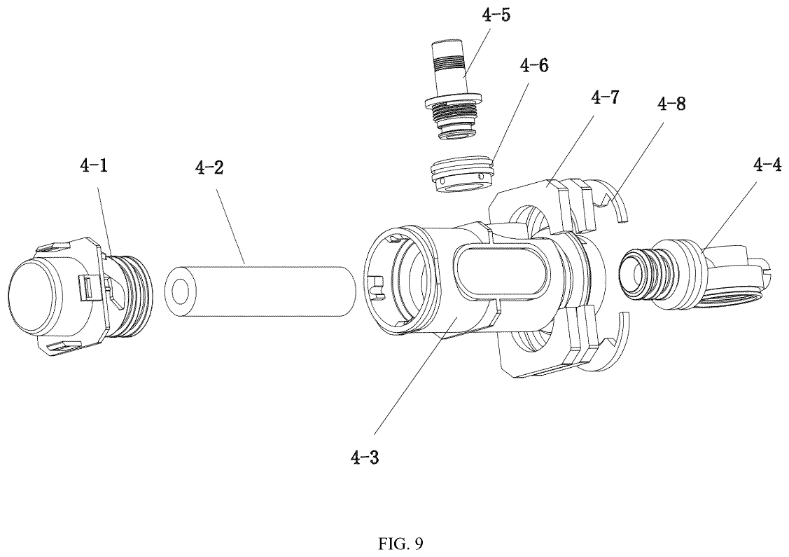

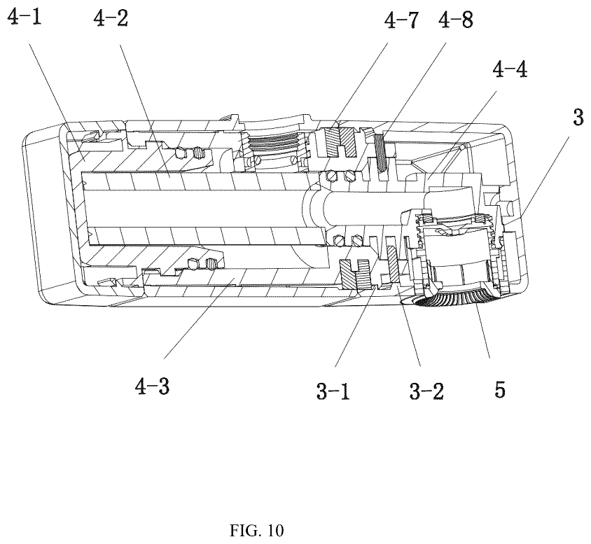

With reference to FIG. 1 to FIG. 10, the technical solution adopted in the specific embodiment is that: a universal bubble facial cleaning instrument with a purification apparatus comprises a middle outer member 1, wherein a water purification mechanism 4 is arranged in the middle outer member 1, and one end of the water purification mechanism 4 is connected with a bubble generator 5. In order to improve the cleaning quality, the water purification mechanism is arranged in this embodiment to purify an added liquid to be used by the bubble generator.

Specifically, the water purification mechanism 4 comprises a composite filter element 4-2 and a filter element groove member 4-3. The composite filter element 4-2 is rotatably arranged in the filter element groove member 4-3, the composite filter element 4-2 is composed of a multilayer non-woven fabric layer 4-2-2, a PP cotton layer 4-2-3 and a carbon fiber layer 4-2-4 from the outside to the inside, and two ends of the composite filter element 4-2 are silica gel gaskets 4-2-1. The multi-layer composite structure can effectively filter impurities in the liquid, and meanwhile, the silica gel gaskets are arranged at two ends to protect a main body. Due to a detachable structure design, the composite filter element may be disassembled for detection after a period of use, and if a lot of impurities have been filtered, the composite filter element may be directly taken out for replacement, thus ensuring a filtering effect in subsequent use.

A front end of the filter element groove member 4-3 is hermetically provided with a filter element bottom cover 4-1, and the filter element bottom cover seals the composite filter element. An outlet section at a tail end of the filter element groove member 4-3 is provided with a fixed edge 4-3-1, and one side of the fixed edge 4-3-1 close to the composite filter element 4-2 is provided with a gap blocker 4-7. In this embodiment, a total of two gap blockers are provided, and the two gap blockers have the same structure. A shape of an outer edge of the gap blocker 4-7 is matched with an internal shape of a tail end of the middle outer member 1, the tail end of the middle outer member 1 is provided with a water outlet outer member 3, the water outlet outer member 3 is clamped with the fixed edge 4-3-1, and a bubble outlet of the bubble generator 5 is exposed from a bottom opening of the water outlet outer member 3. The rotation of the water purification mechanism is mainly realized by the clearance fit between the gap blocker and the filter element groove member and the clamping between the fixed edge and the water outlet outer member, wherein an outer portion of one gap blocker is clamped with the middle outer member, and an inner arc portion of the gap blocker is movably connected with the filter element groove member; and the other gap blocker is matched with the water outlet outer member in shape and clamped with the water outlet outer member. When the water outlet outer member is tightly attached to the skin during use, in order to adjust a water inlet angle, the middle outer member may be directly rotated to drive the water purification mechanism to rotate, so as to adjust a direction of a water inlet end of the water purification mechanism, which is convenient to use. Similarly, when the bubble generator is cleaned, or needs to be temporarily cleaned, a water supply end is not disconnected, and at this time, the water outlet outer member may be rotated to clean the bubble generator by a rotation angle.

More specifically, the outlet section at the tail end of the filter element groove member 4-3 is also provided with a clamping pin 4-8, and the clamping pin 4-8 is two symmetrical semi-annular clamping sheets, which are convenient to mount, and is clamped at a bayonet arranged on the outlet section at the tail end of the filter element groove member 4-3. When the filter element groove member is connected with the water outlet outer member, the clamping pin may press against a shell of the water outlet outer member to rotate, and serve as a supporting structure member to improve the connection stability between the filter element groove member and the water outlet outer member, thus making the rotation more stable.

More specifically, an outlet water flow channel member 4-4 is arranged in the outlet section at the tail end of the filter element groove member 4-3, the outlet water flow channel member 4-4 is hermetically connected with the filter element groove member 4-3 through a sealing ring, and a bottom portion of the outlet water flow channel member 4-4 is provided with a water outlet to be hermetically connected with the bubble generator 5. The outlet water flow channel member is hermetically connected with the filter element groove member, but may still rotate along with the water outlet outer member, and a top portion of the outlet water flow channel member is further provided with the bayonet to match with the clamping pin, so that the outlet water flow channel member is further fastened through the clamping pin, thus improving the connection tightness to prevent the outlet water flow channel member from loosening during rotation.

More specifically, a top portion of the filter element groove member 4-3 is provided with a water inlet, the water inlet is hermetically provided with a copper insert 4-6, the copper insert 4-6 is hermetically provided with a quick inserting plug 4-5, and the quick inserting plug 4-5 penetrates through the middle outer member 1. In this embodiment, the quick inserting plug is a universal plug, which can be connected with plugs with different external diameter specifications, thus having better adaptability.

More specifically, a front end of an inner wall of the water outlet outer member 3 is provided with a first buckle 3-1 and a second buckle 3-2, the first buckle 3-1 is clamped with one side of the fixed edge 4-3-1 close to the gap blocker 4-7, and the second buckle 3-2 abuts against an outer ring of the clamping pin 4-8. The water outlet outer member is provided with two buckles, one buckle is matched with the fixed edge for limitation and may rotate relative to the fixed edge, and the other buckle abuts against the clamping pin, so that the stability of connection and rotation is improved.

More specifically, a front end of the filter element bottom cover 4-1 is provided with a clamping plate, and the clamping plate is provided with a fixing buckle 4-9. One side of the middle outer member 1 is provided with a filter element outer bottom cover 2, an inner wall of the filter element outer bottom cover 2 is provided with a third buckle 2-1, and the third buckle 2-1 is clamped with the fixing buckle 4-9. The arrangement of the buckle connection structure can facilitate mounting and disassembly.

The working principle of the present application is that: in a use process, the quick inserting plug 4-5 can be connected with quick inserting plugs with different specifications to supply water, and an essence may also be introduced for mixed use; the bubble generator 5 may be started to carry out facial cleaning by pressing a switch, the middle outer member 1 may be held to rotate during cleaning, a connected part between the gap blocker 4-7 and the middle outer member 1 rotates along with the middle outer member during rotation, and a connected part between the gap blocker and the water outlet outer member 3 rotates along with the water outlet outer member 3; meanwhile, the fixed edge 4-3-1 is also clamped and rotated with the first buckle 3-1, so as to adjust a water inlet direction and prevent an interference with a use direction; and during cleaning, the middle outer member 1 or the water outlet outer member 3 may also be held to rotate the rest parts by 360 degrees, so that it is convenient to clean and use.

The above are only used to illustrate the technical solutions of the present application, and are not intended to limit the technical solutions. Other modifications or equivalent substitutions made on the technical solutions of the present application by those of ordinary skills in the art without deviating from the spirit and scope of the technical solutions of the present application should be included in the scope of the claims of the present application.

We claim:

1. A universal bubble facial cleaning instrument with a purification apparatus, comprising a middle outer member (1), wherein a water purification mechanism (4) is arranged in the middle outer member (1), one end of the water purification mechanism (4) is connected with a bubble generator (5), the water purification mechanism (4) comprises a composite filter element (4-2) and a filter element groove member (4-3), the composite filter element (4-2) is rotatably arranged in the filter element groove member (4-3), a front end of the filter element groove member (4-3) is hermetically provided with a filter element bottom cover (4-1), an outlet section at a tail end of the filter element groove member (4-3) is provided with a fixed edge (4-3-1), one side of the fixed edge (4-3-1) close to the composite filter element (4-2) is provided with a gap blocker (4-7), a shape of an outer edge of the gap blocker (4-7) is matched with an internal shape of a tail end of the middle outer member (1), the tail end of the middle outer member (1) is provided with a water outlet outer member (3), the water outlet outer member (3) is clamped with the fixed edge (4-3-1), and a bubble outlet of the bubble generator (5) is exposed from a bottom opening of the water outlet outer member (3).

2. The universal bubble facial cleaning instrument with the purification apparatus according to claim 1, wherein the outlet section at the tail end of the filter element groove member (4-3) is also provided with a clamping pin (4-8), and the clamping pin (4-8) is two symmetrical semi-annular clamping sheets and clamped at a bayonet arranged on the outlet section at the tail end of the filter element groove member (4-3).

3. The universal bubble facial cleaning instrument with the purification apparatus according to claim 1, wherein an outlet water flow channel member (4-4) is arranged in the outlet section at the tail end of the filter element groove member (4-3), the outlet water flow channel member (4-4) is hermetically connected with the filter element groove member (4-3) through a sealing ring, and a bottom portion of the outlet water flow channel member (4-4) is provided with a water outlet to be hermetically connected with the bubble generator (5).

4. The universal bubble facial cleaning instrument with the purification apparatus according to claim 1, wherein a top portion of the filter element groove member (4-3) is provided with a water inlet, the water inlet is hermetically provided with a copper insert (4-6), the copper insert (4-6) is hermetically provided with a quick inserting plug (4-5), and the quick inserting plug (4-5) penetrates through the middle outer member (1).

5. The universal bubble facial cleaning instrument with the purification apparatus according to claim 1, wherein a front end of an inner wall of the water outlet outer member (3) is provided with a first buckle (3-1) and a second buckle (3-2), the first buckle (3-1) is clamped with one side of the fixed edge (4-3-1) close to the gap blocker (4-7), and the second buckle (3-2) abuts against an outer ring of the clamping pin (4-8).

6. The universal bubble facial cleaning instrument with the purification apparatus according to claim 1, wherein a front end of the filter element bottom cover (4-1) is provided with a clamping plate, and the clamping plate is provided with a fixing buckle (4-9).

7. The universal bubble facial cleaning instrument with the purification apparatus according to claim 1, wherein one side of the middle outer member (1) is provided with a filter element outer bottom cover (2), an inner wall of the filter element outer bottom cover (2) is provided with a third buckle (2-1), and the third buckle (2-1) is clamped with the fixing buckle (4-9).

8. The universal bubble facial cleaning instrument with the purification apparatus according to claim 1, wherein the composite filter element (4-2) is composed of a multilayer non-woven fabric layer (4-2-2), a PP cotton layer (4-2-3) and a carbon fiber layer (4-2-4) from the outside to the inside, and two ends of the composite filter element (4-2) are silica gel gaskets (4-2-1).
